(19) United States
(12) Patent Application Publication
(10) Pub. No.: US 2006/0115790 A1
(43) Pub. Date: Jun. 1, 2006

(54) Method and accessory for preparing a dental crown or bridge

(76) Inventors: Michael Alon, Rishon Le-Zion (IL); Nikolay Goltzberg, Rishon Letzion (IL); Yosef Peleg, Bat Yam (IL)

Correspondence Address: NATH & ASSOCIATES, 112 South West Street, Alexandria, VA, 22314, US

(21) Appl. No.: 10/996,610

(22) Filed: Nov. 26, 2004

(51) Int. Cl. A61C 8/00

(52) U.S. Cl. 433/173; 433/172

(57) ABSTRACT

A method for producing an abutment cap for use in the preparation of a dental crown or bridge. In one embodiment, data indicative of the abutment cap are inputted to a computer driven rapid prototyping device. The rapid prototyping device is then operated so as to produce the abutment cap by a rapid prototyping process. The method may be used to produce an abutment cap for an abutment not having a cylindrical shape or to produce an abutment cap for an abutment not projecting perpendicularly from the jaw. The invention also provides a system for carrying out the method as well as abutments produced by the method.

### FIELD OF THE INVENTION

The present invention concerns methods and devices for preparing dental crowns and bridges.

### BACKGROUND OF THE INVENTION

In dental restoration, a prosthetic is prepared to replace one or more missing teeth. Such dental prosthetics include bridges, full crowns and partial crowns. Full and partial crowns are supported by remaining portions of the original tooth or teeth and/or by an abutment extending from the jaw bone. Bridges are supported by one or more adjacent teeth structures.

FIG. 1 shows a prior art method for producing a dental crown. The crown is to be placed in a space 2 to replace a missing tooth in a patient's jaw 6. The jaw 6 may bear one or more teeth 8. As shown in FIG. 1a, a dental implant 4 is implanted in the jaw 6. The implant 4 is typically provided with a helical screw thread 10, so that the implant may be screwed into a pre-bored hole in the jaw. The implant 4 is also provided with a socket 12 having screw threads 14 so that an abutment may be screwed into the socket 12, as shown below. An impression 15 of the dentition (FIG. 1b), jaw and gingiva in the vicinity of the space 2 is then obtained. The impression is made from an elastomeric material and provides a negative physical image of the structures in the vicinity of the space 2 where the crown is to be fixed.

A replica 16 of these structures, shown in FIG. 1c, is then obtained by pouring a curable material into the impression 15, and allowing the material to cure. An implant 4′ that is identical to the implant 4 is then screwed into the jaw portion 10′ of the replica 16. An abutment 18′ is then screwed into the socket 12 of the implant 4′. The abutment 18′ has an annular ridge 17 near its bottom to support the crown, as explained below.

As shown in FIG. 1d, molten wax 20 is then applied to the abutment 18′ to fill the space 2′ corresponding to the space 2 in the patient's dentition. After the wax in the space 2′ hardens, the solid wax 5 in the space 2′ (FIG. 1e) is manually shaped so as to acquire an aesthetically acceptable model 24 of the tooth missing from the space 2 (FIG. 1f).

The solid wax model 24 of the missing tooth is then removed from the abutment 18′ (FIG. 1g). The wax model 24 has a cavity 25 whose shape conforms to the surface of the abutment 18′.

As shown in FIG. 1h, the wax model 24 is held with the cavity 25 facing upwards and is fused to a wax rod 11 that is fused at its other end to a metal cylindrical support 13. The wax rod 11 is fused to the wax model 24 by melting the contact region on the wax model 24 and the contact region at the end of the wax model 24 and the end of the rod, joining the model to the rod and allowing the wax to solidify. The other end of the rod 11 is fused to the metal support 13 by melting the wax at the end of the rod 11 in contact with the metal support joining the rod to the support and allowing the wax to solidify.

A cylindrical shell 15 is then fitted onto the metal support 13 (FIG. 1i) to create a cylindrical cavity 19 containing the wax model 24 and the wax rod 11. The cavity 19 is then filled with a curable liquid such as plaster. The liquid is introduced into the cylindrical cavity 19 in such a fashion as to ensure that the cavity 25 of the wax model is completely filled with the liquid and no air remains trapped in the cavity 25. The liquid in the cavity 19 is then allowed to harden, so as to form a negative impression of the wax model 24 and the wax rod 11. The cylindrical shell 15 and the metal support 13 are then removed (FIG. 1j). This produces a solid cylindrical block 26 in which the wax model 24 and the wax rod 11 are embedded. The block 26 is then placed in a hot oven in order to burn and completely disintegrate the wax of the model 24 of the crown and of the rod 11.

Molten crown material 27, which may be a precious metal such as gold, or a ceramic material, is then introduced by centrifugation into the spaces previously occupied by the wax model 24 and wax rod 11 (FIG. 1k).

After the crown material hardens into a crown 30, the material 26 is broken away from the hardened crown material (FIG. 1e) The rod portion 31 of the crown material is then detached from the crown portion 30, so as to produce a crown 30 (FIG. 1m). The crown 30 is thus a replica of the wax model 24. The crown 30 has a cavity 37 having a shape determined by the cavity 25 of the wax model 24.

An abutment 18 that is identical to the abutment 18′ is screwed into the implant 4 in the patient's jaw 6 (FIG. 1n), and the crown 30 is then cemented to the abutment 18 (FIG. 1o).

Since the abutments 18 and 18′ are identical, the cavity 37 of the crown 30, at least in principle, conforms to the surface of the abutment 18. In practice, however, the fit of the crown 30 on the abutment 18 may not be satisfactory. This may be due to the presence of moisture or air trapped between the molten wax and the abutment 18 when the molten wax was applied to the abutment 18′ (FIG. 1d). The solid wax model 24 may also be slightly deformed when removed from the abutment 18′ and manipulated, which would also lead to an unsatisfactory fit of the crown 30 on the abutment 18. The crown 30 must fit on the abutment 4 with a cap of about 100 μm between the crown and the abutment to allow for the presence of a thin layer of cement between the crown and the abutment. A larger or narrower gap will cause the crown to quickly detach from the abutment as a result of forces applied to the crown during chewing. When this occurs, the entire process shown in FIG. 1 must be repeated in order to produce a new crown.

FIG. 2 shows another prior art method for producing a dental crown. This method may be used when the abutment has a cylindrical shape. FIG. 2a shows a replica 16 of a patient's jaw 6 in which an implant 4′ has been implanted, as described above with reference to FIG. 1. An abutment 18′″ having a cylindrical shape has been screwed onto the implant 4′. In this method, before molten wax is applied to the abutment 18′ a plastic abutment cap 32 is applied to the abutment 18′″ (FIG. 2b). FIG. 2c shows the cap 32 in detail. The abutment cap 32 is made from a cylindrical shell 34 that was cut from a commercially available plastic tube. A plastic tube is preferably selected having an inner diameter that is about 200 μm larger than the diameter of the abutment 18′″, and the cylindrical shell 34 is made from a length of the tube conforming to the exposed length of the cylindrical abutment 18′″ above the annular ridge 17. A circular end piece 36 is heat bonded at one end of the cylindrical shell 34 so as to form a cylindrical cavity 38 inside the cap 32. The cap 32 also has an annular ridge 33 at its open end in order to strengthen the open end of the cap and to support the cap on the annular ridge 17 of the abutment 18′″.

As shown in FIG. 2d, after the cap 32 has been placed on the abutment 18″″, molten wax 20 is applied to the cap to fill the space 2′ corresponding to the space 2 in the patient's dentition. After the wax in the space 2′ hardens, the solid wax 5 in the space 2′ (FIG. 2e) is manually shaped so as to acquire an aesthetically acceptable model 24′ of the tooth missing from the space 2 (FIG. 2f). In the model 24′, the shaped wax and the cap 32 form an integral unit.

The model 24′ of the missing tooth is then removed from the abutment 18′″ (i.e. the wax and cap 32 are removed together as a single integral unit). (FIG. 2g). The model 24′ thus has a cavity determined by the cavity 38 of the cap 32 inside the model 24′, and thus conforms to the surface of the abutment 18′″.

As shown in FIG. 2h, the model 24′ is held with the cavity 38 facing upwards and is fused to a wax rod 11 that is fused at its other end to a cylindrical metal support 13. The wax rod 11 is fused to the model 24′ by melting the contact region on the model 24′ and the end of the rod 11 in contact with the model 24′, joining the rod to the model 24′ and allowing the wax to solidify. The other end of the rod 11 is fused to metal support 13 by melting the wax at the end of the rod 11.

A cylindrical shell 15 is then fitted onto the metal support 13 (FIG. 2j) to create a cylindrical cavity 19 containing the model 24′ and the wax rod 11. The cavity 19 is then filled with a curable liquid such as plaster. The liquid is introduced into the cylindrical cavity 19 in such a fashion as to ensure that the cavity 38 of the model is completely filled with the liquid and no air remains trapped in the cavity 38. The liquid in the cavity 19 is then allowed to harden, so as to form a negative impression of the model 24′ and the wax rod 11. The cylindrical shell 15 and the metal support 13 are then removed (FIG. 2j). This produces a solid cylindrical block 26′ in which the model 24′ and the wax rod are embedded. The block 26′ is then placed in a hot oven in order to burn and completely disintegrate the wax rod 11 and the wax and cap 32 in the model 24′ of the crown. A crown 30′ (FIG. 2k) is then made using the solid cylindrical block 26′ as explained above for the cylindrical bloc 26 with reference to FIG. 1. The crown 30′ is thus a replica of the model 24′. The crown 30 has a cavity 37′ having a shape determined by the cavity 38 of the cap 32. An abutment 18″″ that is identical to the abutment 18′″ is screwed into the implant 4 in the patient's jaw 6 (FIG. 2l), and the crown 30′ is then cemented to the abutment 18″ (FIG. 2m).

In principal, this prior method improves the chances of producing a crown having a satisfactory fit, over the other prior art method described above with reference to FIG. 1, because the plastic abutment cap 32 that determines the shape of the cavity 38 of the model 24′ has an inner diameter providing the required gap for the presence of cement. The abutment cap 32 is also less prone to deformation during removal from the abutment and manipulation than an all-wax model. However, the cylindrical shell 34 may slightly deform during manufacture of the cap 32 when the end piece 36 and the annular ledge 33 are heat bonded onto the cylindrical shell 36. Also, the wax in the crown model 24′ may poorly bond to the plastic cap and may thus become detached from the cap 32 during manipulation of the model 24′. Also, as stated above, the cap 32 can be integrated into the model of the crown only when a cylindrical abutment is used that extends perpendicularly from the jaw. In many instances, it is desirable to use an abutment that is a truncated cone. Also, in many instances, it is desirable to use an abutment that extends from the jaw at an angle (i.e. not perpendicularly).

### SUMMARY OF THE INVENTION

In its first aspect, the invention provides a method for producing an abutment cap for an abutment. The abutment cap of the invention has a cavity conforming to the shape of the abutment and may be placed on the abutment prior to the application of wax in the production of a model of a dental crown or bridge. In the case of the production of a model of a dental bridge, an abutment cap of the invention may be placed on each of two or more adjacent abutments, and adjacent caps joined with a rigid bridging material in order to maintain the relative orientation of the caps during the production of the bridge model. The abutment cap becomes part of the crown or bridge model and determines the shape of the cavity of the model. In a presently preferred embodiment, the abutment cap of the invention is produced from an acrylic material.

In accordance with one embodiment of the invention, an abutment cap is produced in a rapid prototyping process. The term “rapid prototyping” is used herein to refer to any processes used to fabricate 3D objects directly from a computer assisted drawing (CAD) data source. Rapid prototyping processes add and bond materials in layers to form objects. Rapid prototyping methods are also known as “solid free form fabrication” and “layered manufacturing” and include such methods as 3D ink-jet printing, selective laser sintering, fused deposition modeling, laminated manufacturing, and stereolithography.

For a given abutment to which an abutment cap is to be produced, the abutment cap is designed using CAD software. The abutment cap is preferably designed having an internal cavity forming a gap of about 100 μm between the cap and the abutment, when the cap is placed on the abutment, for the presence of cement. A rapid prototyping system is used having a processor configured to receive the CAD data indicative of the dimensions and shape of an abutment. The processor is further configured to operate a rapid prototyping device to produce an abutment cap conforming to the shape of the abutment in accordance with the input data. In a preferred embodiment of the invention, the rapid prototyping device is a 3D ink-jet printer and an abutment cap is produced in a 3D ink-jet printing process.

In another embodiment of the invention, an abutment cap is produced in an injection molding procedure. In this embodiment, molten plastic is injected at high pressure into a mold of the desired abutment cap. The mold may be made from metal, for example, steel or aluminum, and precision-machined to form the features of the abutment cap. In a preferred embodiment, the mold is made in a rapid prototyping procedure.

The method of the invention may be used to produce an abutment cap that properly fits on an abutment of any shape including abutments that are truncated cones and abutments that extend from the jaw at any angle. This is in contrast to the prior art abutment cap 32 that can only be used for cylindrical abutments that project perpendicularly from the jaw surface. The method of the invention may be used to produce an abutment cap from a material to which wax bonds well, and that burns and completely disintegrates at temperatures commonly used to burn and disintegrate wax during the manufacture of a dental crown or bridge, as described above.

In its second aspect, the invention provides an abutment cap produced by the method of the invention.

In its third aspect, the invention provides an abutment cap for a non-cylindrical abutment. The abutment cap of this aspect of the invention thus has a non-cylindrical cavity. The abutment in this aspect of the invention may have, for example, a cavity that is a truncated cone, for mounting onto an abutment that is a truncated cone. The cavity may extend at an angle from the opening of the cavity.

In its fourth aspect, the invention provides a system for producing an abutment cap. The system of the invention comprises a rapid prototyping device and a processor. The rapid prototyping device may be, for example, a 3D ink-jet printer, a stereolithography device, a selective laser sintering device, a fused modeling device, or a laminated manufacturing device. In a preferred embodiment of the invention, the rapid prototyping device is a 3D ink-jet printer. The processor is configured to receive and store data indicative of the shape and dimension of an abutment cap and to operate the rapid prototyping device so as to produce an abutment cap conforming to an abutment in accordance with the data that were input to the processor.

It will also be understood that the invention contemplates a computer program being readable by a computer for executing the method of the invention. The invention further contemplates a machine-readable memory tangibly embodying a program of instructions executable by the machine for executing the method of the invention.

Thus, in its first aspect, the invention provides a method for producing an abutment cap for an abutment comprising:

(a) inputting to a computer driven rapid prototyping device data indicative of the abutment cap; and

(b) operating the rapid prototyping device so as to produce the abutment cap by a rapid prototyping process.

In its second aspect, the invention provides a method for producing an abutment cap for an abutment comprising injecting molten plastic into a mold of the cap and forming the cap by an injection molding process.

In its third aspect the invention provides a system for producing an abutment cap for an abutment comprising:

(a) a rapid prototyping device;

(b) a processor configured to receive data indicative of an abutment cap and to drive the rapid prototyping device so as to produce the abutment cap by a rapid prototyping process.

In its fourth aspect, the invention provides an abutment cap for an abutment having a non-cylindrical shape.

In its fifth aspect, the invention provides an abutment cap for an abutment projecting non-perpendicularly from the jaw.

In its sixth aspect the invention provides a method for producing a dental crown or bridge comprising placing on an abutment, an abutment cap of the invention.

In it sixth aspect, the invention provides a program storage device readable by machine, tangibly embodying a program of instructions executable by the machine to perform method steps for producing an abutment cap for an abutment comprising operating a rapid prototyping device so as to produce the abutment cap by a rapid prototyping process.

In its seventh aspect, the invention provides a computer program product comprising a computer useable medium having computer readable program code embodied therein for producing an abutment cap for an abutment, the computer program product comprising computer readable program code for causing the computer to operate a rapid prototyping device so as to produce the abutment cap by a rapid prototyping process.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a prior art method for preparing a dental crown;

FIG. 2 shows another prior art method for preparing a dental crown;

FIG. 3 shows a system for generating an abutment cap for use in the method of the invention;

FIG. 4 shows three abutments and abutment caps for the abutments produced by the method of the invention, and

FIG. 5 shows a method for preparing a dental bridge or crown in accordance with the method of the invention.

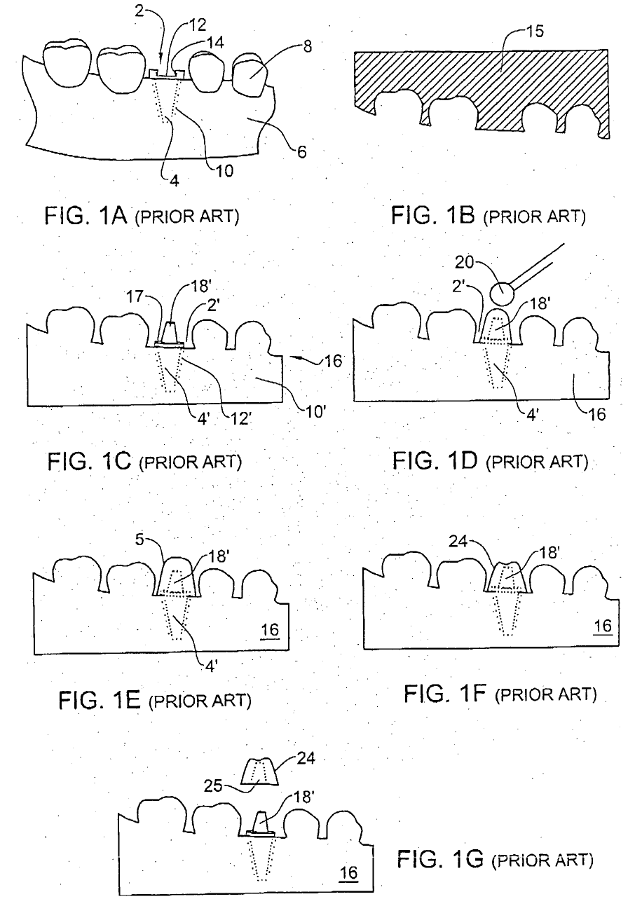

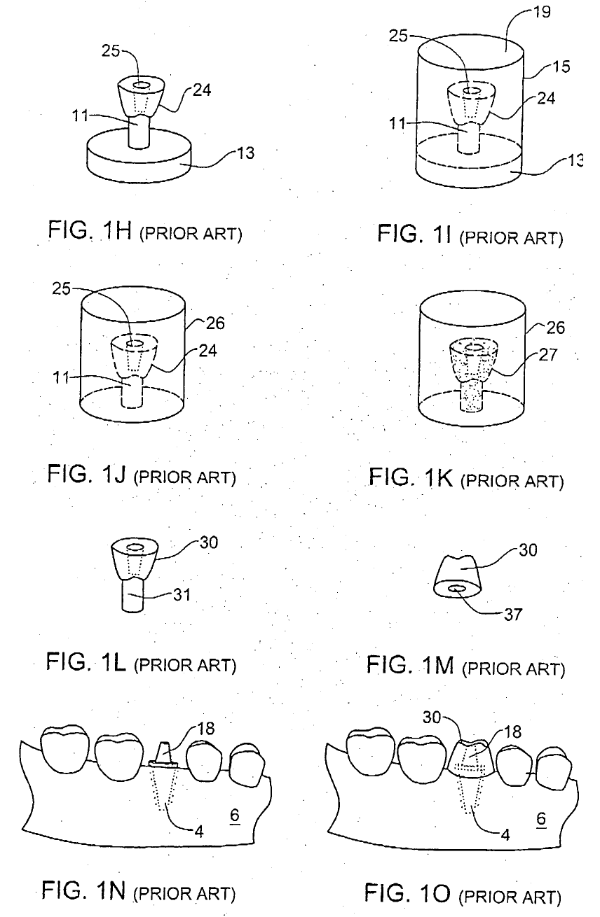

### DETAILED DESCRIPTION OF THE INVENTION

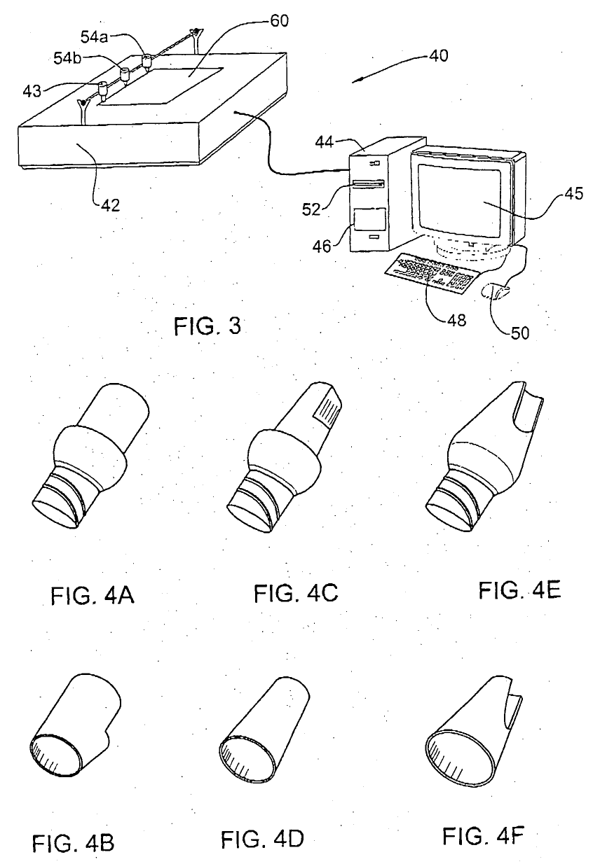

FIG. 3 shows a system 40 for producing an abutment cap in accordance with one embodiment of the system of the invention. The system 40 comprises a rapid prototyping device, such as a 3D ink-jet printer 42, and a processor 44 having a memory 46. This is by way of example only, and the invention may be carried out using any rapid prototyping device or any injection molding system. The system 40 also includes one or more data input devices such as a keyboard 48, a computer mouse 50 and a CD ROM 52. The 3D printer 42 is an injection printer having two printing heads 54a and 54b. The printing head 54a is used to inject a polymeric model material onto a surface 60 and the printing head 54b is used to inject a polymeric support material onto the surface 60. The model material is curable upon exposure to ultraviolet light. An abutment cap is made from the model material. The support material is used to temporarily support the abutment during the printing process, as is known in the art of 3D printing. For example, the support material may be used to fill the cavity of the abutment cap during the printing process and to support an abutment cap not projecting perpendicularly form the surface 60 as the abutment cap is being made. The 3D printer 42 includes a UV lamp 43 for curing the model material after injection onto the surface 60 by the printing heads 54a and 54b, respectfully.

The processor is configured to receive data indicative of the shape and dimension of an abutment to which an abutment cap is to be produced. The data may be in a computer assisted drawing (CAD) format. The processor 44 may be configured to run a CAD program so as to allow a user to design an abutment cap. The data may be input using any one or more of the data input devices associated with the processor. An input abutment cap may be viewed on a display screen 45 with or without the abutment to which it is to be applied. The processor is further configured to drive the printing heads 54a and 54b over the surface 60 so as to produce the designed abutment cap in a 3D printing process as is known in the art of 3D printing in accordance with the input data. At the termination of the 3D printing process, the support material is removed from the abutment.

For example, the inventors have used an Eden 330™ and an Eden 260™ 3D manufactured by Objet Geometries Ltd., Rehovot, Israel printer, to produce abutment caps for several commercially available abutments. The shape and dimensions of several commercial abutments were examined individually under a stereoscopic microscope and an abutment cap was designed to fit each abutment using CAD software. The abutment caps were designed to have a wall thickness of 400 μm and to allow a 100 μm gap between the abutment and the cap for the presence of a thin layer of cement or filler between the crown and abutment. Fullcure 720™ was used as the model material and Fullcure 705™ was used as the support material. Both of these materials are obtainable from Objet Geometries Ltd.

The inventors discovered that wax and common bridging materials bond to abutment caps made from cured acrylic materials such as Fullcure 720™, during the process of producing a dental crown or bridge. The acrylic abutment caps were also found to burn and to completely disintegrate in an oven designed to disintegrate wax in the process of producing a dental crown or bridge as described above. The abutment caps were found not to deform during manipulation of the crown model, so that a crown having a satisfactory fit on the abutment was obtained.

FIG. 4 shows three commercially available abutments obtainable from AlphaBiosystem™ together with the abutment cap that was produced by the method of the invention for each abutment. FIG. 4a shows an abutment 55 that is the AlphaBiosystem™ abutment TLA1, and FIG. 4b shows an abutment cap 56 produced by the method of the invention for this abutment. FIG. 4c shows an abutment 57 that is the AlphaBiosystem™ abutment PLA, and FIG. 4d shows an abutment cap 58 produced by the method of the invention for this abutment. FIG. 4e shows an abutment 59 that is the AlphaBiosystem™ abutment ILA15, and FIG. 4f shows an abutment cap 60 produced by the method of the invention for this abutment. As can be seen, abutment caps were produced having a non-cylindrical shape and that extend non-perpendicularly from the jaw surface. Abutment caps were also produced by the method of the invention for the AlphaBiosystem™ abutments TLASS, TLAL, and PLA15 (not shown).

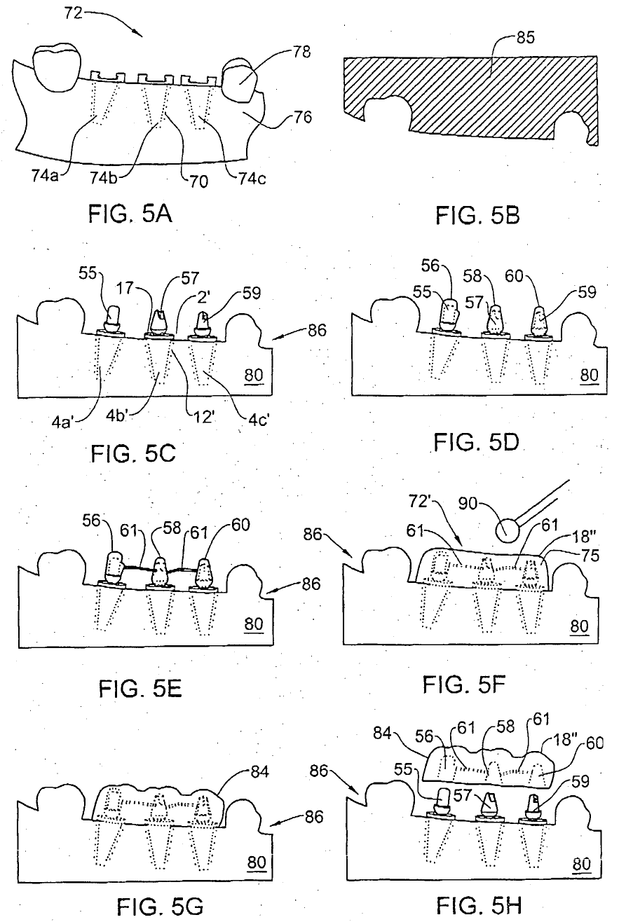

FIG. 5 shows a method for preparing a dental bridge in accordance with the invention. The bridge is to be placed in a space 72 to replace three adjacent missing teeth in a patient's jaw 76. The jaw 76 may bear one or more teeth 78. As shown in FIG. 5a, three dental implants 74a, 74b, and 74c having a helical screw thread 70 are implanted in the jaw 76 by screwing the implants into pre-bored holes in the jaw 76. An impression 85 of the dentition, jaw and gingiva in the vicinity of the space 72 is then obtained (FIG. 5b). The impression is made from an elastomeric material and provides a negative physical image of the structures in the vicinity of the space 72 where the bridge is to be fixed. A replica 86 of these structures, shown in FIG. 5c, is then obtained by pouring a curable material into the impression 85, and allowing the material to cure. Three implants 74a′, 74b′, and 74c′ that are identical to the implants 74a, 74b and 4c are then screwed into the jaw portion 80′ of the replica 86.

Three abutments, such as the abutments 56, 57 and 59 shown in FIG. 4, are then screwed onto the implants 74a′, 74b′, and 74c′ respectively. As explained above, these abutments are non-cylindrical in shape, and as shown in FIG. 5c, they are not parallel to each other when in position in the jaw portion 80 of the replica 86. For each of the three abutments 56, 57, and 59, an abutment cap produced for the abutment by the method of the invention is now placed on the abutment. Thus, as shown in FIG. 5d, the abutment cap 56 shown in FIG. 4b is placed on the abutment 55, the abutment cap 58 is placed on the abutment 57, and the abutment cap 60 is placed on the abutment 59.

Prior to the application of molten wax to the abutment caps, the abutments are joined together by a bridging material 61, as shown in FIG. 5c. The bridging material 61 is preferably made from an acrylic material such as Durale™ that binds to the material of the abutment caps. Now molten wax 90 is applied to the abutment caps to fill the space 72′ corresponding to the space 72 in the patient's dentition. After the wax in the space 72′ hardens, the solid wax 75 in the space 72′ is manually shaped so as to acquire an aesthetically acceptable model 84 of the teeth missing from the space 72 (FIG. 5g). In the model 84, the shaped wax and the abutment caps 56, 58, and 60 form an integral unit.

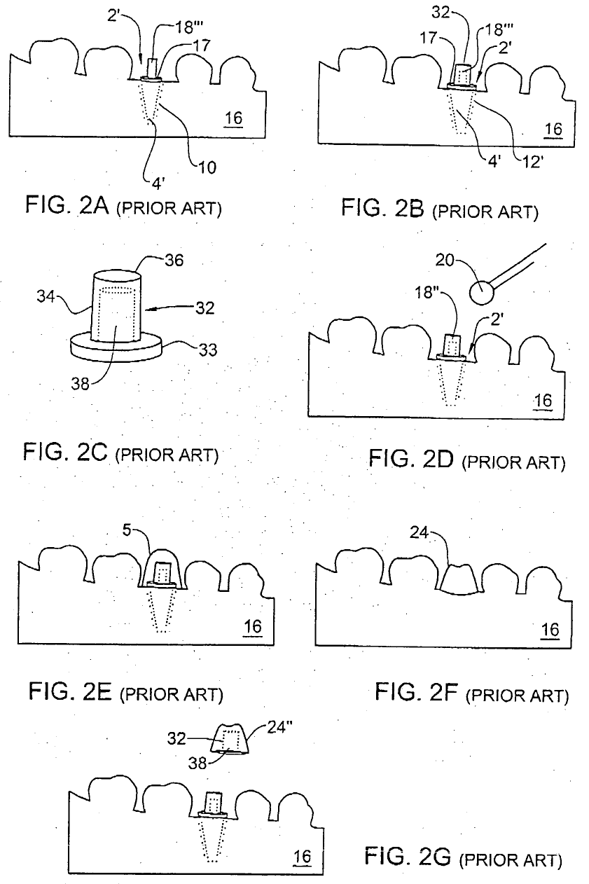

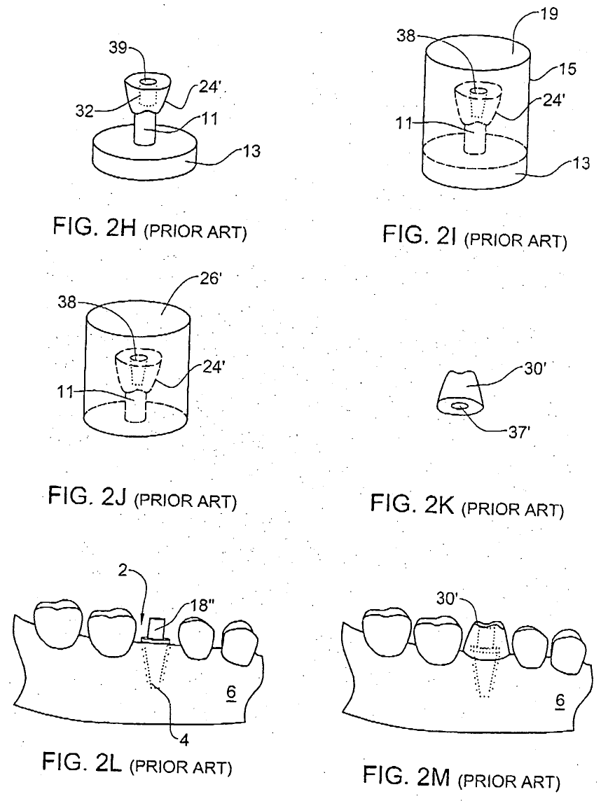

The model 84 of the missing teeth is then removed from the abutments 55, 57, and 59 (i.e. the wax and the abutment caps 56, 58, and 60 are removed together as a single integral unit) (FIG. 5h). The relative orientation of the three abutment caps in the model 84 is maintained as the model is manipulated due to the bridging material 61. The model 84 thus has three cavities determined by the cavities of the abutment caps 56, 58, and 60 inside the model 84, and thus conforms to the surface of the abutments 55, 57, and 59. The model 84 is then used to produce a dental bridge in the same way as the model 24″ was used to produce a dental crown, as explained above with reference to FIG. 2.

1. A method for producing an abutment cap for a dental abutment comprising:
(a) inputting to a computer driven rapid prototyping device data indicative of the abutment cap; and
(b) operating the rapid prototyping device so as to produce the abutment cap by a rapid prototyping process.

2. The method according to claim 1 wherein the data are in a CAD format.

3. The method according to claim 1 wherein the rapid prototyping device is selected from the group comprising:
(a) a 3D ink-jet printer;
(b) a stereolithography device;
(c) a selective laser sintering device;
(d) a fused modeling device and
(e) a laminated manufacturing device.

4. The method according to claim 3 wherein the rapid prototyping device is a 3D ink-jet printer.

5. The method according to claim 4 wherein the abutment cap is formed from an acrylic material

6. A method for producing an abutment cap for an abutment comprising introducing molten plastic into a mold of the cap and forming the cap by a molding process.

7. The method according to claim 6 wherein the molten plastic is introduced into the mold by an injection process.

8. The method according to claim 1 or 6 for producing an abutment cap for an abutment not having a cylindrical shape.

9. The method according to claim 1 or 6 for producing an abutment cap for an abutment not projecting perpendicularly from the jaw.

10. An abutment cap produced by the method of claim 1 or 6.

11. A system for producing an abutment cap for an abutment comprising:
(a) a rapid prototyping device;
(b) a processor configured to receive data indicative of an abutment cap and to drive the rapid prototyping device so as to produce the abutment cap by a rapid prototyping process.

12. The system according to claim 11 wherein the processor is configured to receive the data in a CAD format.

13. The system according to claim 11 wherein the rapid prototyping device is selected from the group comprising:
(a) a 3D ink-jet printer;
(b) a stereolithography device;
(c) a selective laser sintering device;
(d) a fused modeling device and
(e) a laminated manufacturing device.

14. The system according to claim 14 wherein the rapid prototyping device is a 3D ink jet printer.

15. An abutment cap produced by the system of claim 11.

16. An abutment cap for an abutment having a non-cylindrical shape.

17. An abutment cap for an abutment projecting non-perpendicularly from the jaw.

18. A method for producing a dental crown or bridge comprising placing on an abutment, an abutment cap according to any one of claims 10 and 15 to 17.

19. The method for producing a dental crown, according to claim 18 comprising placing on two or more adjacent abutments an abutment cap according to any one of claims 10 and 15 to 17 and joining adjacent abutment caps with a bridging material.

20. The method according to claims 19 wherein the bridging material is an acrylic material

21. A program storage device readable by machine, tangibly embodying a program of instructions executable by the machine to perform method steps for producing an abutment cap for an abutment comprising operating a rapid prototyping device so as to produce the abutment cap by a rapid prototyping process.

22. A computer program product comprising a computer useable medium having computer readable program code embodied therein for producing an abutment cap for an abutment, the computer program product comprising computer readable program code for causing the computer to operate a rapid prototyping device so as to produce the abutment cap by a rapid prototyping process.
